(19) United States
(12) Patent Application Publication
(10) Pub. No.: US 2016/0340871 A1
(43) Pub. Date: Nov. 24, 2016

(54) Engine and Pump Control Device and Working Machine

(71) Applicant: CATERPILLAR SARL, Geneva (CH)

(72) Inventors: Masafumi Ohkubo, Tokyo (JP); Shogo Tada, Tokyo (JP); Seiichi Akiyama, Tokyo (JP); Yuki Ozawa, Tokyo (JP); Yoshihiko Hata, Tokyo (JP)

(73) Assignee: Caterpillar SARL, Geneva (CH)

(21) Appl. No.: 15/112,119

(22) PCT Filed: Jan. 29, 2015
(86) PCT No.: PCT/EP2015/051854

§ 371 Date: Jul. 15, 2016

(30) Foreign Application Priority Data
Jan. 30, 2014 (JP) 2014-015280

(51) Int. Cl. E02F 9/22; B60W 30/188; B60W 10/30; F15B 11/08; B60W 10/06

(52) U.S. Cl. CPC E02F 9/2246; F15B 11/08; E02F 9/2235; B60W 10/06; B60W 10/30; B60W 30/1882; E02F 9/2296; F15B 2211/20553; F15B 2211/275; F15B 2211/70; E02F 3/32

(57) ABSTRACT

Engine and pump control device including controller functioning to, when pump discharge pressure changes from flow rate control area in which pump discharge flow rate is controlled at a low load to output control area in which engine output is controlled at a middle or high load, calculate each value of reduced engine rotating speed and increased engine torque on condition that the product of the engine rotating speed by the engine torque is maintained within a predetermined output level and control engine rotating speed based on these values and control the swash plate angle of the variable displacement pump.

### TECHNICAL FIELD

The present invention relates to an engine and pump control device and a working machine which simultaneously control engine speed and engine torque.

### BACKGROUND ART

FIG. 9 schematically depicts conventional control. The given desired engine speed set using an accelerator dial 21 is transmitted to an engine controller 15 by a machine controller 19. Furthermore, the machine controller 19 transmits a signal for controlling a pump swash plate, to a solenoid proportional valve 16s for electro/hydraulic conversion so as to generate a given desired pump torque in an output control region that is set using the accelerator dial 21. A pump regulator 16 is then controlled using a hydraulic signal generated by the solenoid proportional valve 16s. The pump regulator 16 thus controls a pump swash plate angle.

As depicted in FIG. 10, in a flow rate control region, control is performed based on a maximum pump discharge flow rate determined by the engine speed and the pump swash plate angle. In an output control region, the characteristics of the pump and the engine are determined by outputs from the pump and the engine (pump discharge pressure×pump discharge flow rate, the engine speed×engine torque).

In conventional engine control (isochronous control and droop control), the target engine speed is kept constant, and the engine torque (also referred to as the pump torque) output to the pump is controlled to provide target power. However, this control has low fuel efficiency.

On the other hand, a control device for a working machine has been disclosed which includes at least one variable displacement hydraulic pump driven by a motor, at least one hydraulic actuator driven by pressure oil from the hydraulic pump, and rotation speed control means for controlling the rotation speed of the motor. The control device includes mode selection means for selecting a control mode related to the motor, load pressure detection means for detecting a load pressure on the hydraulic pump, and target rotation speed setting means for which the rotation speed of the motor is preset in order to reduce the motor rotation speed with increasing load pressure on the hydraulic pump. When the mode selection means selects a particular mode, the target rotation speed setting means references the preset motor rotation speed in association with the load pressure on the hydraulic pump detected by the load pressure detection means to determine the corresponding motor rotation speed. Based on the motor rotation speed, the target rotation speed setting means sets the target rotation speed for the rotation speed control means (see, for example, Patent Literature 1).

The control device enables reduction in the motor rotation speed to improve fuel consumption, using the mode selection performed by the mode selection means. Furthermore, in the needed load region, the control device can suppress degradation of performance (a decrease in working speed) caused by a reduced pump discharge flow rate, and improve working efficiency.

[Patent Literature 1] Japanese Patent No. 4188902

The target rotation speed setting means in the control device for the working machine acts to improve fuel consumption and working efficiency when the mode selection means selects a particular mode, that is, by switching from a standard mode to an economical mode. However, disadvantageously, such an effect is exerted only when the mode is switched to the economical mode.

Furthermore, the conventional control generally involves approximately unique setting for the engine speed and the engine torque in accordance with the accelerator dial. However, for work in a medium load region and a high load region, to keep outputs is important rather than the engine speed and the engine torque.

### DISCLOSURE OF THE INVENTION

With the foregoing in view, it is an object of the present invention to provide an engine and pump control device and a working machine with the engine and pump control device both of which are effective for improving fuel efficiency and working efficiency with keeping predetermined outputs and without mode switching.

An invention according to claim 1 is an engine and pump control device which controls the engine speed based on a desired engine speed set by engine speed setting means and which controls engine torque by controlling a swash plate angle of a variable displacement pump driven by the engine, the engine and pump control device including a controller having a function to determine values of the engine speed that has been reduced and the engine torque that has been increased under a condition that a product of the engine speed and the engine torque is within an identical output region, when a flow rate control region where a pump discharge flow rate is controlled changes to an output control region where an engine output is controlled, and to control the engine speed and the swash plate angle of the variable displacement pump based on the values.

In an invention according to claim 2, the controller in the engine and pump control device according to claim 1 has a function to determine a desired reduced engine speed based on a desired output resulting from multiplication of a desired pump torque by the desired engine speed specified by the engine speed setting means, an actual desired output that is actually desired, and a target reduced engine speed resulting from subtraction, from the desired engine speed, of a target engine speed set based on fuel consumption data and further subtract the desired reduced engine speed from the desired engine speed to determine a new desired engine speed, and control the engine speed in accordance with the new desired engine speed, and a function to divide the desired output by the new engine speed to determine a new desired pump torque, and control the swash plate angle of the variable displacement pump using the new desired pump torque.

An invention according to claim 3 is a working machine including a machine body, a working device mounted in the machine body, an engine and pump device that supplies hydraulic oil to a hydraulic actuator that drives the machine body and the working device, and the engine and pump control device according to claim 1 or claim 2 which controls the engine and pump device.

According to the invention in claim 1, the controller determines the values of the engine speed that has been reduced and the engine torque that has been increased under the condition that the product of the engine speed and the engine torque is kept in the identical output region, when the flow rate control region where the pump discharge flow rate is controlled changes to the output control region where the engine output is controlled, and controls the engine speed and the swash plate angle of the variable displacement pump based on the values. Thus, fuel efficiency and working efficiency are effectively improved with keeping predetermined outputs and without mode switching in the flow rate control region or in the output control region.

According to the invention in claim 2, the controller has the function to determine the desired reduced engine speed based on the desired output determined by the engine speed setting means, the actual desired output that is actually desired, and the target reduced engine speed resulting from the subtraction, from the desired engine speed, of the target engine speed set based on fuel consumption data and further subtracts the desired reduced engine speed from the desired engine speed to determine the new desired engine speed and control the engine speed in accordance with the new desired engine speed, and the function to divide the desired output by the new desired engine speed to determine the new desired pump torque and control the swash plate angle of the variable displacement pump using the new desired pump torque. The controller can optimize the balance between the engine speed and the engine torque so as to effectively improve fuel efficiency and working efficiency with keeping predetermined outputs and without mode switching.

According to the invention in claim 3, a working machine can be provided that is effective for improving fuel efficiency and working efficiency with keeping predetermined outputs and without mode switching.

### BRIEF DESCRIPTION OF THE DRAWINGS

FIG. 1 is a map of fuel consumption with respect to the engine speed and engine torque depicting an embodiment of an engine and pump control device according to the present invention.

FIG. 2 is a block diagram schematically depicting a control system for the control device.

FIG. 3 is a flowchart schematically depicting a control method implemented by the control device.

FIG. 4(a) is a characteristic diagram depicting an example of control of a pump discharge flow rate, the engine speed, engine torque, and engine output with respect to a pump discharge pressure according to a conventional technique, and FIG. 4 (b) is a characteristic diagram depicting a first control example of the pump discharge flow rate, the engine speed, the engine torque, and the engine output with respect to the pump discharge pressure according to the present invention.

FIG. 5 is a characteristic diagram depicting a second control example according to the present invention.

FIG. 6 is a characteristic diagram depicting a third control example according to the present invention.

FIG. 7 is a side view depicting an example of a working machine according to the present invention.

FIG. 8 is a block diagram schematically depicting a control device according to the present invention.

FIG. 9 is a block diagram schematically depicting a conventional control system.

FIG. 10 is a characteristic diagram depicting an example of control of the pump discharge flow rate, the engine speed, and the engine torque with respect to the pump discharge pressure according to a conventional technique.

### BEST MODE FOR CARRYING OUT THE INVENTION

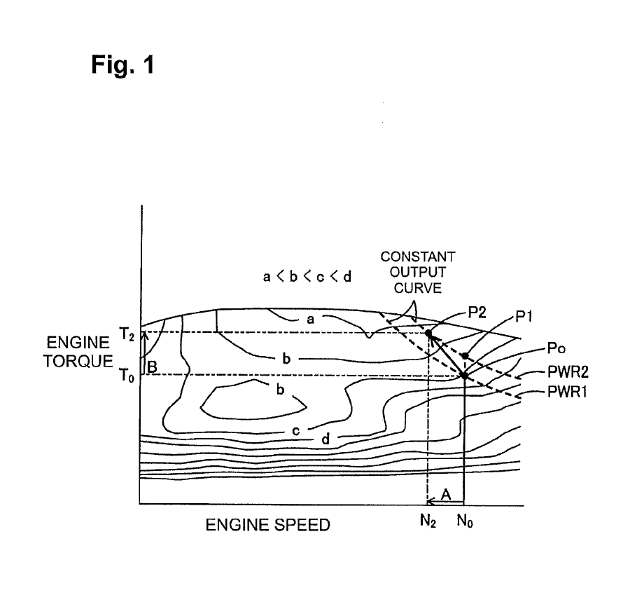

The present invention will be described below based on an embodiment depicted in FIGS. 1 to 8.

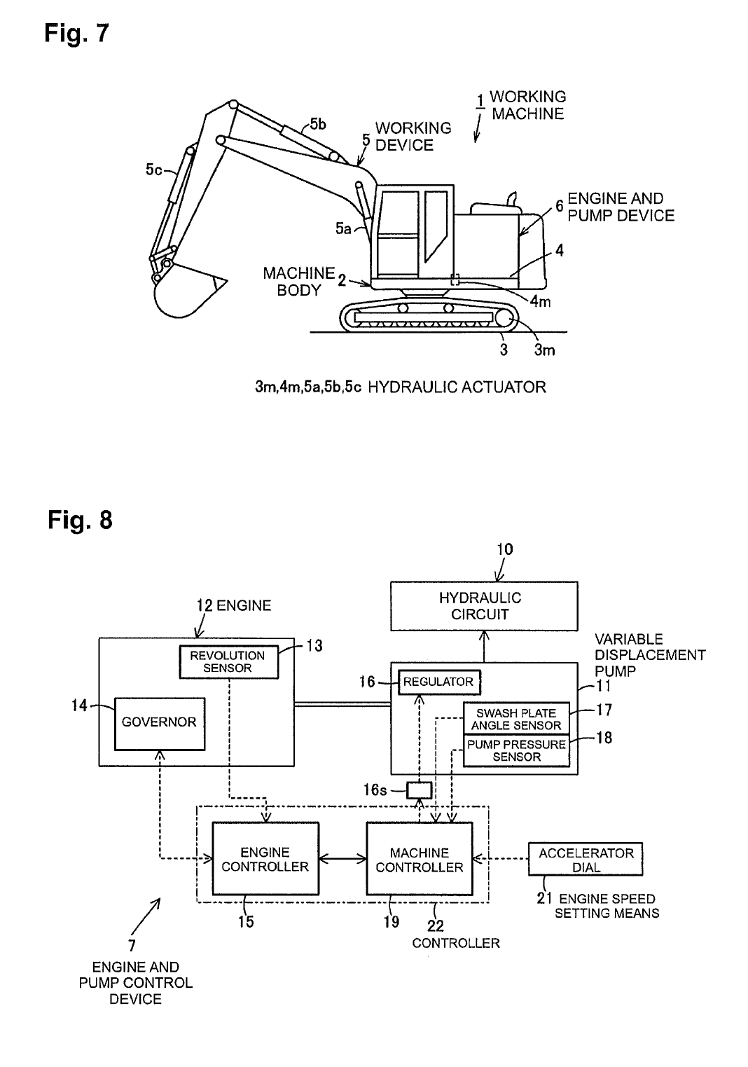

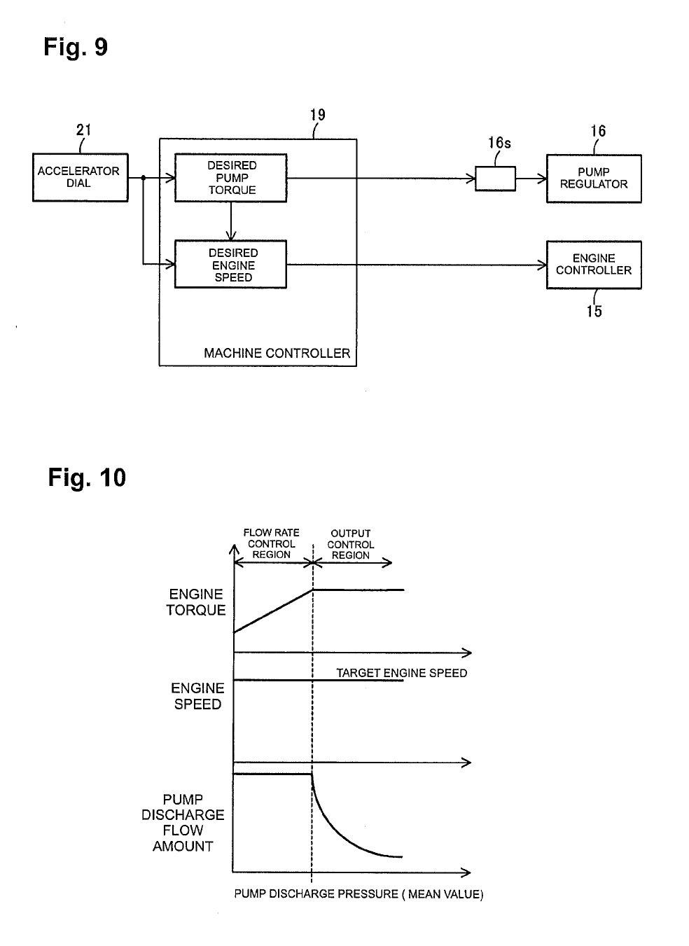

FIG. 7 depicts an excavator serving as a working machine 1. The working machine 1 has a machine body 2 including a lower traveling body 3 that can be moved by a traveling motor 3m and an upper slewing body 4 provided on the lower traveling body 3 and which can be slewed by a slewing motor 4m. The upper slewing body 4 includes a working device 5 driven by hydraulic cylinders 5a, 5b, and 5c.

The machine body 2 includes an engine and pump device 6 supplying hydraulic oil to hydraulic actuators 3m, 4m, 5a, 5b, and 5c that drive the machine body 2 and the working device 5.

FIG. 8 schematically depicts an engine and pump control device 7 that controls the engine and pump device 6. The engine and pump control device 7 controls the capacity (swash plate angle) of a variable displacement pump 11 that supplies hydraulic oil serving as a working fluid to a hydraulic circuit 10 such as a control valve which controls the hydraulic actuators 3m, 4m, 5a, 5b, and 5c. The engine and pump control device 7 further controls the engine speed of an engine 12 that drives the variable displacement pump 11.

The engine 12 includes a revolution sensor 13 that detects the engine speed and a governor 14 such as an electronic governor which is used to control the engine speed. The revolution sensor 13 and the governor 14 are connected to an engine controller 15 for fuel injection control.

The variable displacement pump 11 includes a pump regulator 16 that receives a hydraulic signal output by a solenoid proportional valve 16s for electro/hydraulic conversion to control the tilt angle of a swash plate (hereinafter referred to as the swash plate angle) serving as a pump capacity varying means, a swash plate angle sensor 17 that detects the swash plate angle controlled by the pump regulator 16 as a pump capacity control position, and a pump pressure sensor 18 that detects a pump discharge pressure. The swash plate angle sensor 17 and the pump pressure sensor 18 are connected to a machine controller 19. The swash plate angle sensor 17 may be omitted, and in that case, the swash plate angle is calculated based on a hydraulic signal for swash plate angle control which allows control of the pump regulator 16.

The machine controller 19 connects to an accelerator dial 21 serving as engine speed setting means. The accelerator dial 21 has a plurality of accelerator positions to allow a specified engine speed-torque characteristic to be selected for each of the accelerator positions.

The engine controller 15 and the machine controller 19 are connected together to exchange information with each other. The engine controller 15 and the machine controller 19 are collectively referred to as a controller 22.

The engine and pump control device 7 has a function to control the engine speed of the engine 12 based on the desired engine speed set using the accelerator dial 21 and to control the swash plate angle of the variable displacement pump 11 driven by the engine 12 to control the engine torque.

The controller 22 has a function to determine values of the engine speed that has been reduced and the engine torque that has been increased under the condition that a product of the engine speed and the engine torque is within an identical output region, when a flow rate control region where a pump discharge flow rate under a low load is controlled to stay approximately constant changes to an output control region where an engine output under a medium load and a high load is controlled to stay approximately constant, and to control the engine speed and the swash plate angle of the variable displacement pump 11 based on the values.

The engine output is determined by the machine controller 19 by making an appropriate calculation using an engine fuel injection status obtained from the engine controller 15 or the pump swash plate angle detected by the swash plate angle sensor 17 or calculated based on the hydraulic signal for swash plate angle control and the pump discharge pressure detected by the pump pressure sensor 18. Furthermore, whether the load status is low or medium or high is determined depending on the engine output or the pump discharge output.

(Summary of Control for an Engine Fuel Consumption Map)

FIG. 1 depicts a map of fuel consumption with respect to the engine speed and the engine torque (hereinafter simply referred to as the torque) of the engine. FIG. 1 indicates that, even with the same output, brake specific fuel consumption (hereinafter referred to as BSFC) represented by a, b, c, and d (a<b<c<d) in FIG. 1 varies in accordance with the engine speed and the torque. The BSFC results from division, by the engine output (net horsepower), of the amount of fuel injection consumed during one cycle of the engine (unit: g/(kW·h)).

In the present control, with the above-described characteristics taken into account, the engine speed and the torque are controlled to allow the engine and the pump to operate in the identical output region at a point with a low fuel consumption.

For example, in FIG. 1, when the torque is increased from point Po to point P1 in an output region between PWR1 and PWR2 by performing isochronous control in which the torque is controllably increased or reduced with the engine speed kept at No, the BSFC is improved only insignificantly.

On the other hand, in the output region between PWR1 and PWR2, the engine speed is reduced by A to move from No at point Po to N2 at point P2, whereas the torque is increased by B to move from To at point Po to N2 at point P2, the BSFC is improved much more significantly than in the isochronous control.

In short, fuel efficiency can be improved with a comparable amount of work (=the engine speed×torque) kept by performing integral control of reducing the engine speed while increasing the torque in the same output region so as to allow the use of the engine speed and the torque at the optimum point.

(Summary of Control for Pump Efficiency)

Like the engine fuel consumption map, pump efficiency varies in accordance with the engine speed (that is, the pump rotation speed) and the output torque (that is, the pump capacity varying in accordance with the pump swash plate angle). The pump efficiency increases with low engine speed and high output torque (larger swash plate angle=larger capacity).

In the present control, with the pump efficiency taken into account as is the case with the engine fuel consumption map, the engine speed and the torque are integrally controlled so that operation is performed at a point where a desired flow rate for the machine body is met in the flow rate control region, while the optimum fuel efficiency is achieved in the output control region.

(General Flow of Control)

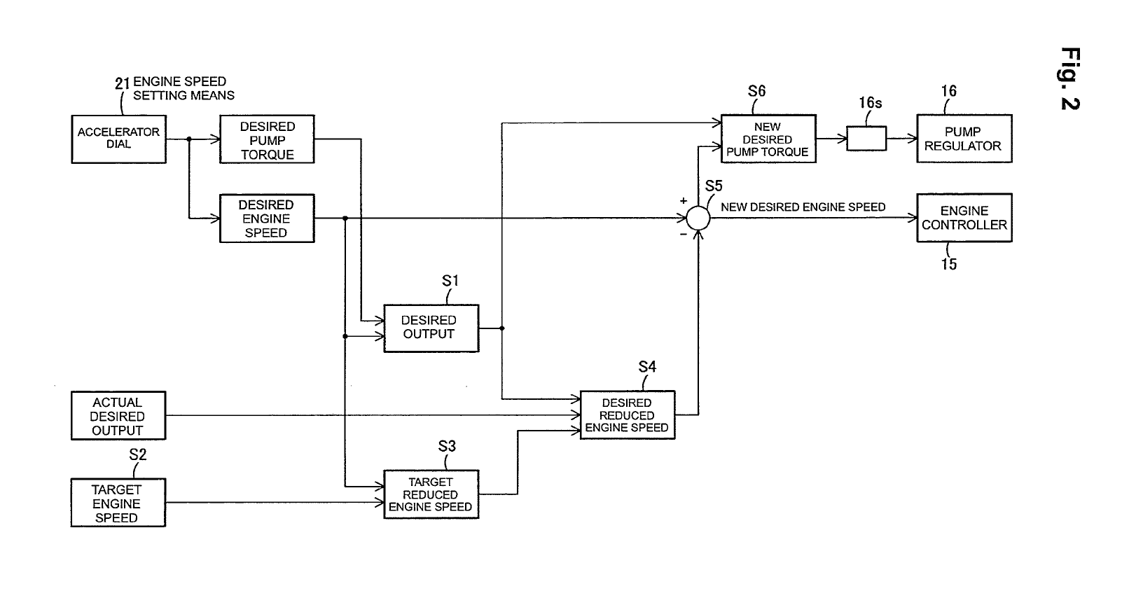

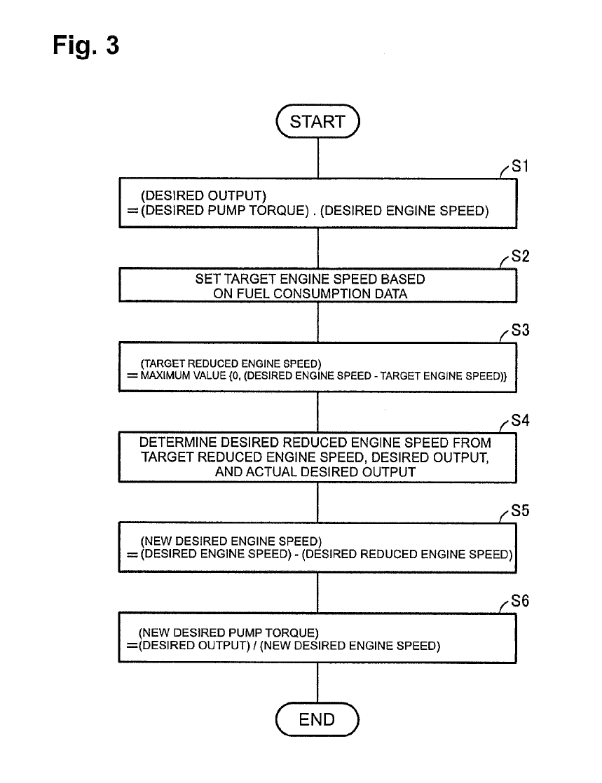

With reference to a block diagram depicted in FIG. 2 and a flowchart depicted in FIG. 3, control will be described in brief in which the controller 22 smoothly varies the engine speed and the desired pump torque to target values as the output desired by the machine body 2 (actual desired output) approaches a specified output (desired output).

(Step S1)

The desired pump torque is multiplied by the desired engine speed specified in the accelerator dial 21 to determine the desired output.

(Step S2)

The target engine speed is set based on fuel consumption data such as the fuel consumption map depicted in FIG. 1.

(Step S3)

The target engine speed is determined based on the difference between the target engine speed in step S2 and the desired engine speed. When the target engine speed is larger than the desired engine speed, the target reduced engine speed is equal to 0.

(Step S4)

The desired reduced engine speed is determined based on the desired output determined in step S1, the actual desired output calculated from the pump discharge pressure and the like by the machine controller 19, and the target reduced engine speed determined in step S3. For example, the desired reduced engine speed can be determined regardless of which of the parameters varies and how the parameter varies by predetermining the values of the desired reduced engine speed varying in accordance with the three parameters, namely, the desired output, the actual desired output and the target reduced engine speed, and mapping the values in a memory for the machine controller 19.

(Step S5)

The desired reduced engine speed determined in step S4 is subtracted from the desired engine speed. The resultant difference is transmitted to the engine controller 15 as a new desired engine speed.

(Step S6)

A new desired pump torque is calculated from the desired output determined in step S1 and the new desired engine speed determined in step S5 in accordance with the following general formula:

Output [kW]=torque [Nm]×the engine speed [rpm]×2π÷600.

A signal (pump swash plate angle control signal) allowing the pump swash plate to be controlled in accordance with the resultant value of the output is transmitted to the solenoid proportional valve 16s for electro/hydraulic conversion. The solenoid proportional valve 16s generates a hydraulic signal, and the pump regulator 16 is controlled in accordance with the hydraulic signal to control the pump swash plate angle.

(Example of Control)

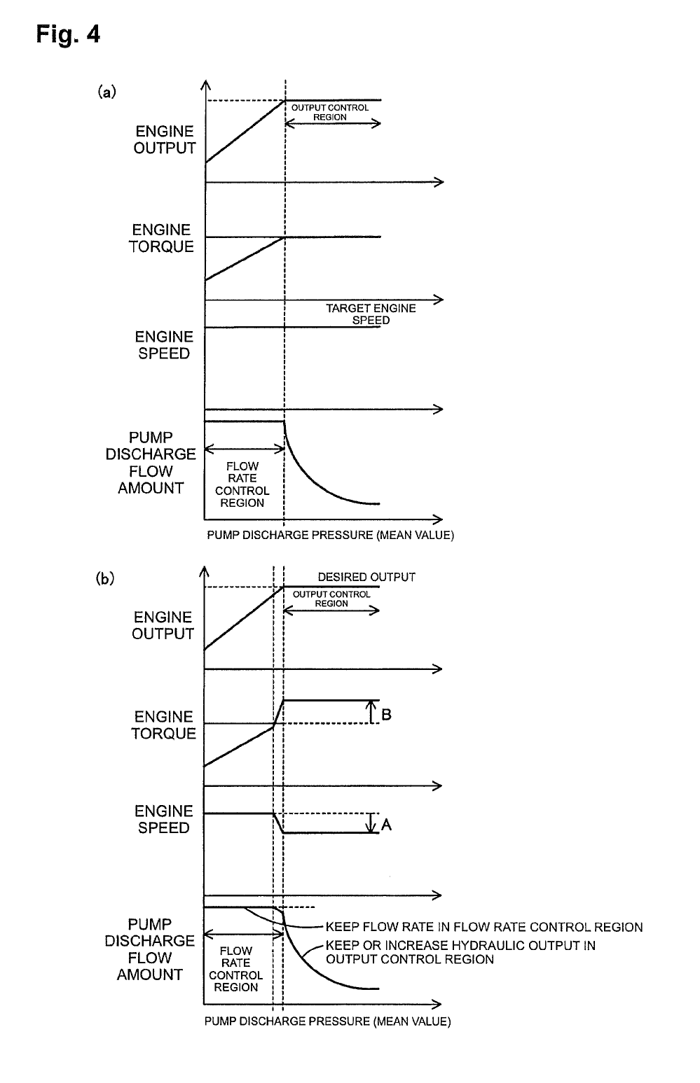

FIG. 4 depicts a comparison of the relations among the pump discharge pressure, the pump discharge flow rate, the engine speed, the engine torque, and the engine output between a case where the current control scheme (a) is applied and a case where an applied example (b) of the control scheme according to the present invention. The use of the applied example (b) allows pump efficiency and fuel efficiency to be improved by controllably optimizing the balance between the engine speed and the torque with the relation between the pump discharge pressure and the pump discharge flow rate kept equivalent to (or approximate to) the current control scheme (a) which relation is used for the work of the excavator.

That is, when the balance between the engine speed and the torque is optimized as depicted by A and B in FIG. 1, with keeping the engine output (=the engine speed×torque), a needed amount of work (output) can be kept even with a change in the balance between the engine speed and the torque. Thus, the above-described increase in efficiency can be achieved.

An example of the increase in efficiency is as follows. When the load is low during constant-flow-rate control (flow rate control region) depicted in FIG. 4 (b), the amount of work (working speed) is proportional to the pump flow rate. Thus, efficiency can be improved by setting the engine speed to a large value in order to keep the working speed and setting the pump input torque (engine output torque) to a low torque (small swash plate angle).

On the other hand, when the load is medium or high during the constant-flow-rate control (output control region) depicted in FIG. 4 (b), efficiency can be improved by setting the engine speed to a small value (rotation speed reduction amount A) and setting the pump torque to a high torque (torque increase amount B), in view of pump efficiency and engine fuel efficiency.

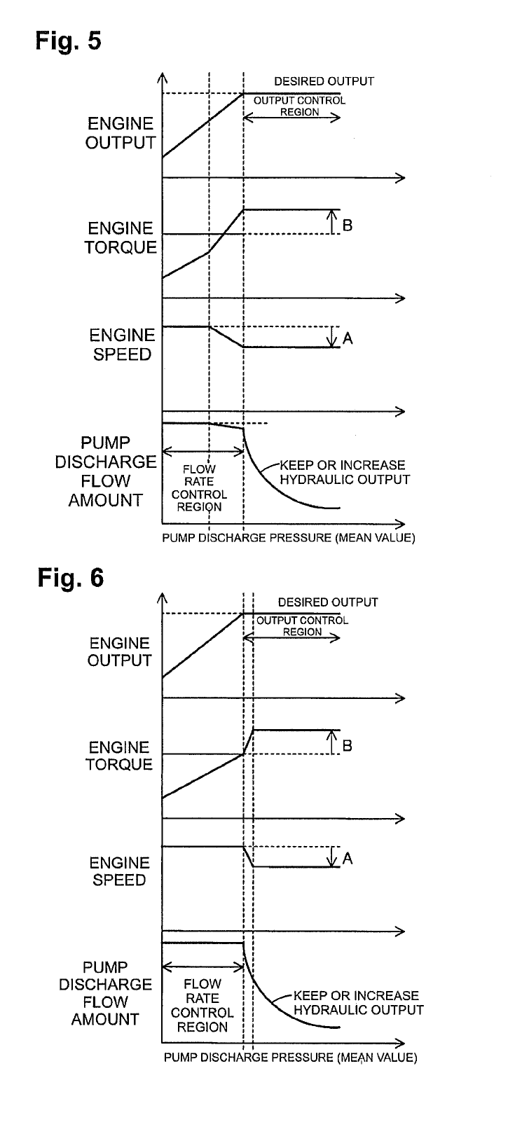

FIG. 5 and FIG. 6 depict other applied examples according to the present invention. The start point of a variation in the engine speed can be freely changed as in the applied example depicted in FIG. 4 (b) and in the other applied examples depicted in FIG. 5 and FIG. 6, by changing the parameter of the desired reduced engine speed in step S4 depicted in FIG. 2 and FIG. 3.

FIG. 4 (b) and FIG. 5 depict examples in which the engine speed and the torque vary smoothly to target values (−A and +B) as the engine output approaches the target desired output, that is, at a point where the flow rate control region to the output control region. The variation is slower in FIG. 5 than in FIG. 4 (b).

FIG. 6 depicts an example where, after the engine output reaches the target desired output, the engine torque and the torque vary smoothly to the target values (−A, +B).

As described above, the controller 22 determines the values of the engine speed that has been reduced (rotation speed reduction amount A) and the engine torque that has been increased (torque increase amount B) under the condition that the product of the engine speed and the engine torque is kept in the identical output region, when the flow rate control region where the pump discharge flow rate is controlled under a low load changes to the output control region where the engine output is controlled under a medium load and a high load, and controls the engine speed and the swash plate angle of the variable displacement pump based on the values. Thus, fuel efficiency and working efficiency are effectively improved with keeping predetermined outputs and without mode switching in the flow rate control region and in the output control region.

Furthermore, as depicted in FIG. 2 and FIG. 3, the controller 22 has the function to control the engine speed of the engine 12 and the function to control the swash plate angle of the variable displacement pump 11. The controller 22 can thus optimize the balance between the engine speed and the engine torque so as to effectively improve fuel efficiency and working efficiency with keeping predetermined and without mode switching.

Moreover, the working machine 1 can be provided which is effective for improving fuel efficiency and working efficiency with keeping predetermined output and without perform mode switching in the flow rate control region and in the output control region.

The engine speed-torque characteristic depicted in FIG. 1 is an example where the isochronous control is performed when the torque is lower than at the point Po. However, the present invention is applicable to droop control.

### INDUSTRIAL APPLICABILITY

The present invention has industrial applicability for companies involved in manufacture, distribution, and the like of engine and pump control devices.

### EXPLANATION OF REFERENCE NUMERALS

1 Working machine
2 Machine body
3m, 4m, 5a, 5b, 5c Hydraulic actuator
5 Working device
6 Engine and pump device
7 Engine and pump control device
11 Variable displacement pump
12 Engine
21 Accelerator dial as engine speed setting means
22 Controller

1. An engine and pump control device which controls the engine speed of an engine based on a desired engine speed set by engine speed setting means and which controls an engine torque by controlling a swash plate angle of a variable displacement pump driven by the engine, the engine and pump control device comprising:
a controller having a function to determine values of the engine speed that has been reduced and the engine torque that has been increased under a condition that a product of the engine speed and the engine torque is within an identical output region, when a flow rate control region where a pump discharge flow rate is controlled changes to an output control region where an engine output is controlled, and to control the engine speed and the swash plate angle of the variable displacement pump based on the values.

2. The engine and pump control device according to claim 1, wherein the controller has:
a function to determine a desired reduced engine speed based on a desired output resulting from multiplication of a desired pump torque by the desired engine speed specified by the engine speed setting means, an actual desired output that is actually desired, and a target reduced engine speed resulting from subtraction, from the desired engine speed, of a target engine speed set based on fuel consumption data and further subtract the desired reduced engine speed from the desired engine speed to determine a new desired engine speed, and control the engine speed of the engine in accordance with the new desired engine speed; and
a function to divide the desired output by the new desired engine speed to determine a new desired pump torque, and control the swash plate angle of the variable displacement pump using the new desired pump torque.

3. A working machine comprising;
a machine body;
a working device mounted in the machine body;
an engine and pump device that supplies hydraulic oil to a hydraulic actuator that drives the machine body and the working device; and
the engine and pump control device according to claim 1 which controls the engine and pump device.

4. A working machine comprising:
a machine body;
a working device mounted in the machine body;
an engine and pump device that supplies hydraulic oil to a hydraulic actuator that drives the machine body and the working device; and
the engine and pump control device according to claim 2 which controls the engine and pump device.
